(19) United States
(12) Patent Application Publication
(10) Pub. No.: US 2007/0236332 A1
(43) Pub. Date: Oct. 11, 2007

(54) METHOD FOR READING TAG IN MOBILE RFID ENVIRONMENT

(76) Inventors: ChengHao QUAN, Yanji City (CN); Hae-Won SON, Daejeon (KR); Hee-Sook MO, Daejeon (KR); Ji-Hoon BAE, Daejeon (KR); Dong-Han LEE, Daejeon (KR); Gil-Young CHOI, Daejeon (KR); Cheol-Sig PYO, Daejeon (KR); Jong-Suk CHAE, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/689,609

(22) Filed: Mar. 22, 2007

(30) Foreign Application Priority Data
Mar. 22, 2006 (KR) 10-2006-0026262
Feb. 27, 2007 (KR) 10-2007-0019653

(51) Int. Cl. H04Q 5/22

(52) U.S. Cl. 340/10.1; 340/572.1; 340/10.2; 370/310

(57) ABSTRACT

Provided is a method for reading a tag in a mobile Radio Frequency Identification (RFID) environment. The tag reading method effectively identifies a tag by repeatedly transmitting a tag identification request in a predetermined time to prevent collision among RFID readers, when a plurality of RFID readers access to a tag. The method for reading a tag in a mobile RFID environment, which includes the steps of: a) transmitting a tag identification request signal to a tag; b) waiting for an acknowledgement signal to be transmitted from the tag; and c) when no acknowledgement signal is transmitted from the tag, retransmitting the tag identification request signal after a predetermined delay time passes.

### CROSS-REFERENCE(S) TO RELATED APPLICATIONS

The present invention claims priority of Korean Patent Application Nos. 10-2006-0026262 and 10-2007-0019653, filed on Mar. 22, 2006, and Feb. 27, 2007, respectively, which are incorporated herein by reference.

### BACKGROUND OF THE INVENTION

1. Field of the Invention

The present invention relates to a method for reading a tag in a Radio Frequency Identification (RFID) environment; and, more particularly, to a tag reading method for effectively accessing to a medium when a plurality of RFID readers access to a tag in a mobile RFID environment.

2. Description of Related Art

A tag is attached to an object to be recognized and tag information is read by a Radio Frequency Identification (RFID) reader of a mobile terminal, which will be referred to as mobile RFID reader, hereinafter. The tag information read by the RFID reader is transmitted to a server through the Internet and processed in real-time. The processed tag information is transmitted back to the mobile terminal and provides diverse services based on the tag information. The RFID technology is combined with diverse communication services and wireless Internet technology, and it is expected to bring about a great deal of additional values throughout the entire society including Information Technology (IT) industries.

Media access methods in a general fixed RFID system include a frequency hopping (FH) method and a Listen Before Talk (LBT) method. Since the frequency hopping method has a wide bandwidth and a lot of channels, it is mostly used in the U.S. On the other hand, most European countries use the LBT method which has a narrow bandwidth and a small number of channels. Since South Korea has a bandwidth of 5.5 MHz and 27 channels, the country adopts the LBT in most cases. According to the LBT method, the RFID reader checks out the state of a medium before it transmits a request and only when the medium is available, it transmits a request. The performance of the LBT method is affected by the threshold power level of a channel, sampling cycle, and the frequency number of sampling. Particularly, the threshold power level is largely affected by an electric wave propagation environment of a corresponding region. Thus, it is difficult to set up the threshold power level in a mobile RFID environment, and hidden terminals may cause a problem of collision.

Also, there is a problem that the states of all channels should be checked out due to possible interference between an RFID reader and a tag. Although the number of RFID readers is relatively small, the states of channels should be checked out necessarily.

Meanwhile, in a fixed RFID environment, there are a plurality of tags around an RFID reader, and a reading range is between about 3 cm and 5 cm. The fixed RFID environment requires a high reading rate and short reading time, and how to prevent collision between tags is the main issue of the fixed RFID environment.

On the other hand, in the mobile RFID environment, there are a plurality of RFID readers around a tag, and the reading range is not further than 1 m. The main issue of the mobile RFID environment is collision among RFID readers, and interference between RFID readers and interference between an RFID reader and a tag are major problems of the mobile RFID environment. This is because when multiple RFID readers request to access to a single tag, the tag cannot read the signals simultaneously transmitted from the RFID readers due to wideband characteristics. Therefore, it is required to develop a method for avoid interference and/or collision among a plurality of RFID readers to make the RFID readers share the same medium and communicate with a tag.

### SUMMARY OF THE INVENTION

An embodiment of the present invention is directed to provide a method for providing a tag reading method that can effectively identify a tag by repeatedly transmitting a tag identification request in a predetermined time to prevent collision among Radio Frequency Identification (RFID) readers, when a plurality of RFID readers access to a tag.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a tag reading method in a mobile RFID environment, which includes the steps of: a) transmitting a tag identification request signal to a tag; b) waiting for an acknowledgement signal to be transmitted from the tag; and c) when no acknowledgement signal is transmitted from the tag, retransmitting the tag identification request signal after a predetermined delay time passes.

### BRIEF DESCRIPTION OF THE DRAWINGS

FIG. 1 is a block view illustrating a mobile Radio Frequency Identification (RFID) system in accordance with an embodiment of the present invention.

FIG. 2 illustrates a mobile RFID environment to which the present invention is applied.

FIG. 3 is a flowchart describing a tag identification process in a mobile RFID environment in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. When it is considered that detailed description on a related art may obscure the points of the present invention, the description will not be provided herein.

Hereinafter, features of a mobile RFID environment that is considered in the present invention will be described, and specific embodiments of the present invention will be described in detail with reference to the accompanying drawings.

The mobile RFID environment includes a limited number of RFID readers within a short tag identification radius, and the time taken for an RFID reader to access to a medium is very short. It takes several milliseconds for an RFID reader to read tag information.

For example, a phonograph record information may be acquired by identifying a tag attached to an advertisement medium such a poster, or information on an object exhibited in a museum may be acquired by reading tag identification information of a tag attached to an exhibition panel. In this case, it is highly unlikely to assume that more than 10 RFID readers are simultaneously present within a tag identification radius.

When it is assumed that an RFID reader generates an identification request every second, the media access method should be able to process 10 requests per second. In other words, although collision occurs as RFID readers compete to use a medium, it is possible to provide a service by retransmitting the identification request after a predetermined random time, which is not longer than 200 ms.

When a user sees a tag and presses a corresponding key in a mobile terminal, a tag identification request is generated. Tag information of the tag is identified and transmitted to a server connected to the Internet through a subscriber network of the mobile terminal, and the server transmits information that is stored therein and corresponds to the tag information to the mobile terminal. This process takes several seconds.

Actually, it is measured that it takes 5 seconds generally for a mobile terminal to access to a wireless Internet portal of a mobile communication service provider, i.e., a mobile carrier. Considering that users are tolerable to a delay of additional 2 seconds to acquire information on an object, the total delay time taken for a user to access to a service and see a result on a screen is about 7 seconds at the maximum.

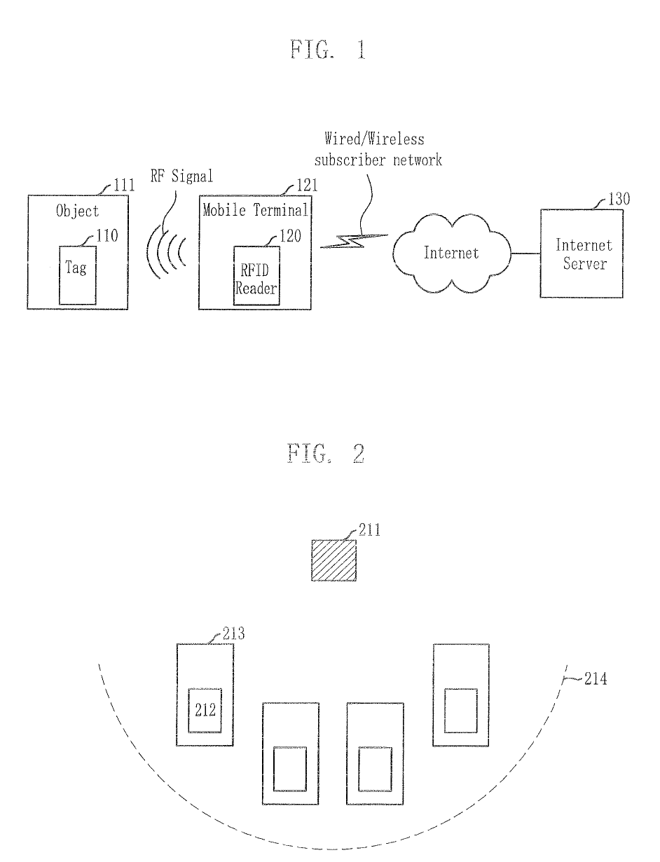

FIG. 1 is a block view illustrating a mobile RFID system in accordance with an embodiment of the present invention. Referring to FIG. 1, the mobile RFID system includes a tag 110 attached to an object 111, an RFID reader 120 mounted on a mobile terminal 121, and an Internet server 130.

The RFID reader 120 communicates RF signals with the tag 110, and the mobile terminal 121 with the RFID reader 120 is connected to the Internet server 130 through a wired/wireless subscriber network and the Internet.

The mobile RFID system is operated as follows. A user requests the RFID reader 120 for tag identification by pressing a predetermined key in the mobile terminal 121. The RFID reader 120 modulates RF signals having a predetermined carrier frequency and sends a query to the tag 110.

The tag 110 transmits its identification information to the RFID reader 120 according to a protocol. The RFID reader 120 transmits received tag identification information to a server 141 connected to the Internet 140 through a wired/wireless subscriber network connected to the mobile terminal 121.

The server 130 processes the received tag identification information and transmits corresponding information requested by the user back to the mobile terminal 120. The user performs the next operation in response to the received information.

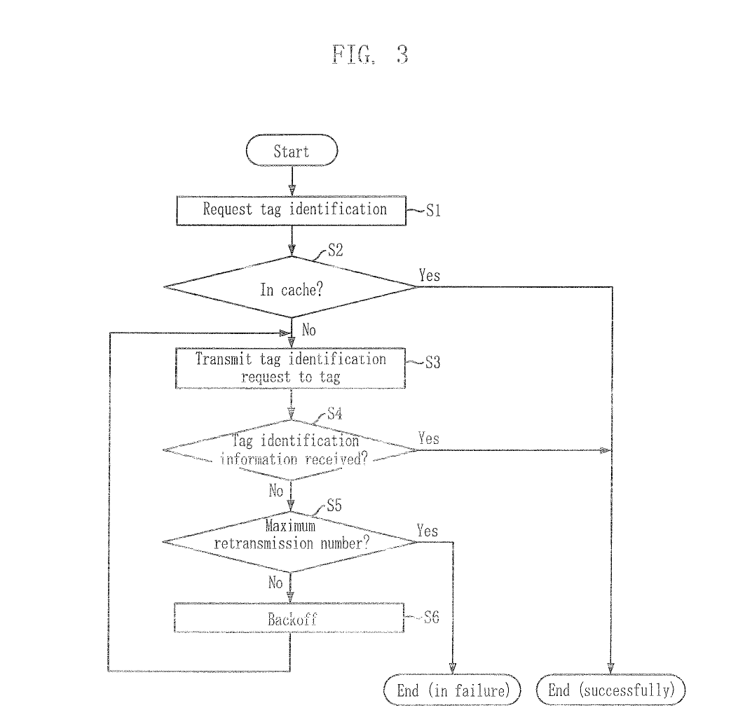

FIG. 2 illustrates a mobile RFID environment to which the present invention is applied. Referring to FIG. 2, there are a plurality of mobile terminals 213 including an RFID reader 212 around a tag 211. Only the RFID readers 212 within the tag identification region can identify the tag 211. The number of RFID readers 211 around the tag 211 is generally less than 10 in the mobile RFID environment, and the tag identification region 214 is not wider than 1 m.

FIG. 3 is a flowchart describing a tag identification process in a mobile RFID environment in accordance with an embodiment of the present invention. In step S1, a mobile terminal creates tag identification request upon receipt of key input data from a user.

In step S2, the mobile terminal determines whether there is information corresponding to the tag identification request in a cache. When the information is in the cache, the tag identification stored in the cache is outputted and then the process is terminated. According to the embodiment of the present invention, the cache stores the tag identifier received in response to the tag identification request for time to live (TTL) time. When the TTL is set up to be 1 second, the RFID reader transmits only one tag identification request per second although the user repeatedly presses the corresponding key in the mobile terminal. In this case, when there are n RFID readers around a tag, it can be assumed that n tag identification requests are generated.

Meanwhile, when the tag identifier is not in the cache, the RFID reader transmits the tag identification request signal to the tag, and communicates with the tag based on the communication protocol in step S3.

To be specific, the RFID reader and the tag communicate with each other and make query and response according to a communication protocol, and they transmit and receive tag identifier. To take an example of the international standard protocol Gen2 Protocol, the communication between an RFID reader and a tag is composed of a query transmission step in the RFID reader, an RN16 reception step in the tag, an acknowledgement (ACK) transmission step in the RFID reader, and a tag identifier reception step. The time taken for identifying a tag is referred to as tag identification time, which starts from transmission of a query and ends at time when a tag identifier is received.

The following Table 1 presents theoretical tag identification time according to diverse RFID reader-tag transmission rates. In a system realized according to an embodiment of the present invention, the tag identification time is shorter than 5 ms.

TABLE 1

| | | | | | | | | | | |
|---|---|---|---|---|---|---|---|---|---|---|
| Transmission | Tari | 25 us | 25 us | 25 us | 25 us | 12.5 us | 12.5 us | 6.25 us | 6.25 us | 6.25 us |
| Rate | Rate | 40k | 53.3k | 64k | 80k | 80k | 160k | 160k | 320k | 640k |

| | | | | | | | | | |
|---|---|---|---|---|---|---|---|---|---|
| Tag Identification | 5.79 | 4.73 | 4.20 | 3.67 | 2.92 | 1.86 | 1.49 | 0.955 | 0.689 |
| Time (ms) | | | | | | | | | |

When more than one RFID reader simultaneously attempt to communicate with a tag in the above-described process, none of the RFID readers that have attempted for communication cannot receive the tag identifier of the tag.

The RFID readers competitively attempt to access to a medium based on the tag identification time shown in the Table 1.

The following Table 2 shows a media access success rate when the number of the RFID readers increases from 2 to 10, when RFID readers generating a tag identification request every second has tag identification time of 5 ms. For example, when 10 RFID readers transmit a tag identification request every second and the media access time is 5 ms, the probability that an RFID reader independently uses the medium and succeeds in communication with the tag is 90.48%.

TABLE 2

| | Number of RFID readers | | | | | | | | |
|---|---|---|---|---|---|---|---|---|---|
| | 2 | 3 | 4 | 5 | 6 | 7 | 8 | 9 | 10 |
| Media | 98.02 | 97.04 | 96.08 | 95.12 | 94.18 | 93.24 | 92.31 | 91.39 | 90.48 |
| Access | | | | | | | | | |
| Success | | | | | | | | | |
| Rate | | | | | | | | | |
| (%) | | | | | | | | | |

In step S4, the RFID reader determines whether tag information is received successfully. When the tag information is received successfully, the RFID reader outputs the received tag identifier to the mobile terminal.

When the tag information reception is failed, the RFID reader attempts retransmission in the following process. The probability that 10 RFID readers generate a tag identification request every second, competitively access to the medium only to fail, and successfully access to the medium by retransmitting the tag identification request is over 87.96%.

In short, when the RFID reader fails to receive the tag information, it is determined whether the retransmission is performed more than the maximum retransmission frequency number in step S5. When the number of retransmission exceeds the maximum retransmission frequency number, the RFID reader outputs failure information to the mobile terminal. Then, the user performs the identification again from the step S1 by pressing the key in the mobile terminal.

When the number of retransmission is less than the maximum retransmission frequency number, the RFID reader performs back-off in step S6, and repeats the process from the step S3. In the back-off process, the RFID reader delays the tag identification request for a predetermined random time before it retransmits the tag identification request. The delay time is calculated based on the following Equation 1.

delayTime=rand (0, (the maximum number of request arrival×tag identification time×2×2) Equation 1

where delayTime is delay time, and the maximum number of request arrival is the maximum number of requests arrived every second.

For example, when a total of 10 RFID readers generate a tag identification request every second, the number of maximum request arrival is 10. The rand( ) function generates an arbitrary number between the first factor and the second factor.

To sum up, an RFID reader that has failed to identify a tag waits for the predetermined time and repeats the tag identification request transmission process from the step S3.

The following Table 3 shows a simulation result of the tag identification method according to an embodiment of the present invention. When 10 RFID readers generating a tag identification request every second access to the medium based on a tag identification time of 5 ms to communicate with the tag, the number of access success, the access success rate, and retransmission access success rate are as shown in Table 3. Table 3 presents a simulation result of RFID readers each generating 100,000 tag identification requests, i.e., 1,000,000 tag identification requests in total.

TABLE 3

| | The number of | Access | Retransmission |
|---|---|---|---|
| | access success | success rate | access success rate |
| Initial access | 906,437 | 90.644% | — |
| 1st retransmission | 79,334 | 7.933% | 84.79% |
| 2nd retransmission | 11,753 | 1.175% | 82.60% |
| 3rd retransmission | 1,998 | 0.200% | 80.69% |
| 4th retransmission | 380 | 0.038% | 79.50% |
| 5th retransmission | 78 | 0.008% | 79.59% |
| The total number of | 999,980 | 99.998% | — |
| access success | | | |
| The total number of | 20 | 0.002% | — |
| access failure | | (failure rate) | |

It can be seen from the Table 3 that when retransmission was carried out five times, 99.998% of the entire tag identification requests were successful. Also, the simulation result showed that 90.644% of the entire tag identification requests took 5 ms for tag identification. At the worst, the tag identification time for a tag identification request that is retransmitted five times was 859 ms.

The method of the present invention may be realized as a program and stored in a computer-readable recording medium such as CD-ROM, RAM, ROM, floppy disks, hard disks, magneto-optical disks and the like. Since the process can be easily implemented by those skilled in the art to which the present invention pertains, further description on it will not be provided herein.

The method of the present invention can prevent collision and identify a tag at a high tag reading rate by retransmitting tag identification requests, when a plurality of RFID readers access to a medium to identify a single tag.

Also, the present invention can easily realizes a mobile RFID environment by performing the retransmission after a predetermined delay time to thereby make multiple RFID readers to effectively identify a tag.

While the present invention has been described with respect to the specific embodiments, it will be apparent to those skilled in the art that various changes and modifications may be made without departing from the spirit and scope of the invention as defined in the following claims.

What is claimed is:

1. A method for reading a tag in a mobile Radio Frequency Identification (RFID) environment, comprising the steps of:
a) transmitting a tag identification request signal to a tag;
b) waiting for an acknowledgement signal to be transmitted from the tag; and
c) when no acknowledgement signal is transmitted from the tag, retransmitting the tag identification request signal after a predetermined delay time passes.

2. The method of claim 1, wherein the tag identification request signal is retransmitted less than a predetermined maximum retransmission frequency number in the tag identification request signal retransmission step c).

3. The method of claim 1, wherein the predetermined delay time is determined based on a maximum number of request arrival and a tag identification time.

4. The method of claim 3, wherein the predetermined delay time is determined based on a maximum number of request arrival per second and a tag identification time.

5. The method of claim 4, wherein the predetermined delay time is determined based on an equation expressed as:
delayTime=rand(0,(the maximum number of request arrival×tag identification time×2×2)
where delayTime is delay time, and the maximum number of request arrival is the maximum number of requests arrived every second.
